(19) United States
(12) Patent Application Publication
(10) Pub. No.: US 2026/0211706 A1
(43) Pub. Date: Jul. 23, 2026

(54) INTERFACE AUTOMATION USING CONFORMAL PREDICTION FOR ENHANCED TASK EXECUTION

(71) Applicant: Dell Products L.P., Round Rock, TX (US)

(72) Inventors: Pradyumna Kumar Prusty, Jajapur (IN); Kailash Talreja, Mumbai (IN); Saurabh Jha, Austin, TX (US)

(21) Appl. No.: 19/033,189

(22) Filed: Jan. 21, 2025

(51) Int. Cl. G06F 9/451

(52) U.S. Cl. CPC G06F 9/451

(57) ABSTRACT

A method for automating an adaptive multi-agent user interface (UI), the method includes receiving at least one trained model from an adaptive learning module, sending the at least one trained model to a host agent, and generating, using a user input as an input to the at least one trained model, an application plan via the host agent, where the application plan includes a first instruction for a first app agent and a second instruction for a second app agent. Additionally, the method includes executing, using the application plan, the first instruction using the first app agent, where the executing includes performing at least one UI task, executing, using the application plan, the second instruction using the second app agent, and generating, based on executing the first instruction and the second instruction, an output to a user.

### BACKGROUND

Users often interact with computer applications via an application's user interface (UI). UIs are often composed of various UI elements such as buttons, menus, and input fields. Many tasks performed using these UI elements by the users are straightforward and repetitive. Automating these tasks can improve efficiency, save time, and minimize errors.

### BRIEF DESCRIPTION OF DRAWINGS

Certain embodiments of the disclosure will now be described with reference to the accompanying drawings. However, the accompanying drawings illustrate only certain aspects or implementations of the disclosure by way of example and are not meant to limit the scope of the claims.

FIG. 1 shows a diagram of a system in accordance with one or more embodiments.

FIG. 2 shows a flowchart of a method for automating an adaptive multi-agent UI in accordance with one or more embodiments.

FIG. 3 shows a flowchart of a method for generating an application plan in accordance with one or more embodiments.

FIG. 4 shows a flowchart of a method for executing an application plan in accordance with one or more embodiments.

FIG. 5 shows a flowchart of a method for generating trained models in accordance with one or more embodiments.

FIG. 6 shows a diagram of a computing system in accordance with one or more embodiments.

### DETAILED DESCRIPTION

The increasing complexity and diversity of tasks performed on operating system (OS) applications present significant challenges in UI automation. Traditional automation tools often struggle with reliability, adaptability, and security, thereby leading to inefficiencies and user frustration. Furthermore, existing systems lack the ability to provide confidence measures for their actions, resulting in unpredictable and error-prone task execution. The need for a more intelligent, adaptive, and secure UI automation systems is apparent as users demand seamless and reliable interaction with their applications. As a result of the limitations discussed above, embodiments of the disclosure are directed to a UI automation system that leverages adaptive multi-agent coordination and conformal prediction techniques. The advanced UI automation system presents a comprehensive solution for UI automation for applications, transforming complex and time-consuming processes into simple tasks achievable through natural language inputs.

The components of the UI automation system include a dual-agent framework, conformal prediction techniques, an adaptive learning mechanism, an enhanced control interaction module, and a robust safeguard mechanism. The dual-agent framework includes a host agent and app agent group, which work together to efficiently navigate and execute tasks across multiple applications. The host agent is responsible for analyzing user inputs, selecting appropriate applications, and formulating detailed plans. On the other hand, app agents of the app agent group execute specific actions within the selected applications based on the detailed plans provided by the host agent. This coordinated approach allows for seamless task execution across multiple applications, emulating human-like interaction with the UI.

Further, the conformal prediction techniques (i.e., prediction techniques used to measure how well new data fits within a model's past patterns) provide confidence measures for task assignments and UI interactions, ensuring higher reliability and accuracy in task completion. Moreover, the adaptive learning module enables continuous improvement of task execution based on user interactions and historical data. This approach allows the system to dynamically adapt to changing UI conditions and user requirements, overcoming the limitations of traditional automation tools, ensuring higher accuracy, and reducing the likelihood of errors.

Additionally, the control interaction module supports a wide range of UI actions, such as clicking, text input, annotation, and summarization, and controls facilitating seamless and versatile interaction with various applications. Furthermore, the robust security module identifies potentially risky operations (i.e., sending an email with sensitive information, deleting data containing sensitive information, duplicating data containing sensitive information, etc.), and seeks user approval before execution to reduce the risk of accidental errors and increase the security provided by the system.

Specific embodiments will now be described with reference to the accompanying figures.

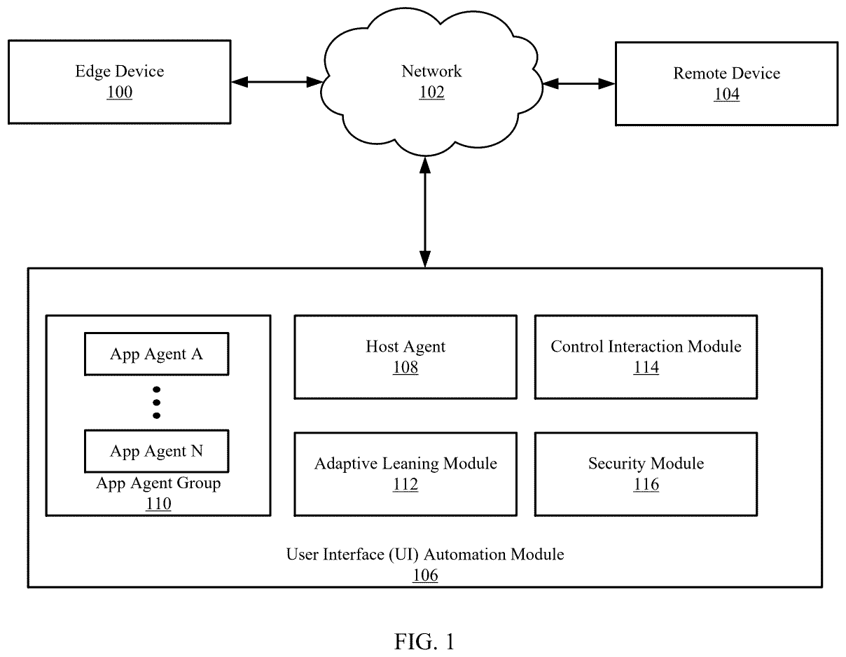

FIG. 1 shows a system in accordance with one or more embodiments. The system may include an edge device (100), a network (102), a remote device (104), a UI automation module (106), a host agent (108), an app agent group (110), an adaptive learning module (112), a control interaction module (114), and a security module (116). The system may include additional, fewer, and/or different components without departing from the scope of the embodiments disclosed herein. Each component may be operably/operatively connected to any of the other components via any combination of wired and/or wireless connections. Each of these system components is described below.

In one or more embodiments, the edge device (100), the remote device (104), the UI automation module (106), the host agent (108), the app agent group (110), the adaptive learning module (112), the control interaction module (114), and the security module (116) may be operatively connected to one another through the network (102) (e.g., a local area network (LAN), a wide area network (WAN) such as the Internet, a mobile network, any other network type, or a combination thereof). Further, the network (102) may encompass various interconnected, network-enabled subcomponents (or systems) (e.g., switches, routers, gateways, etc.) that may facilitate communications between the aforementioned components. Moreover, the edge device (100), the remote device (104), the UI automation module (106), the host agent (108), the app agent group (110), the adaptive learning module (112), the control interaction module (114), and the security module (116) may communicate with one another using any combination of wired and/or wireless communication protocols.

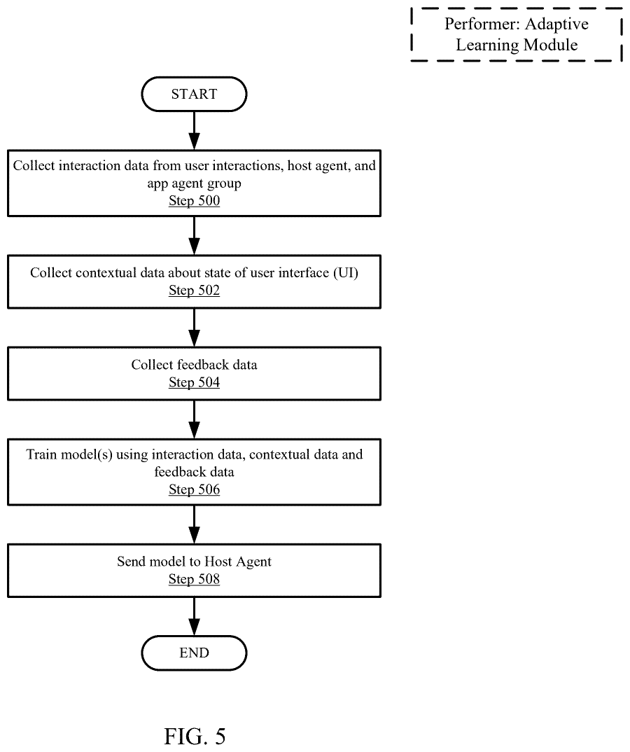

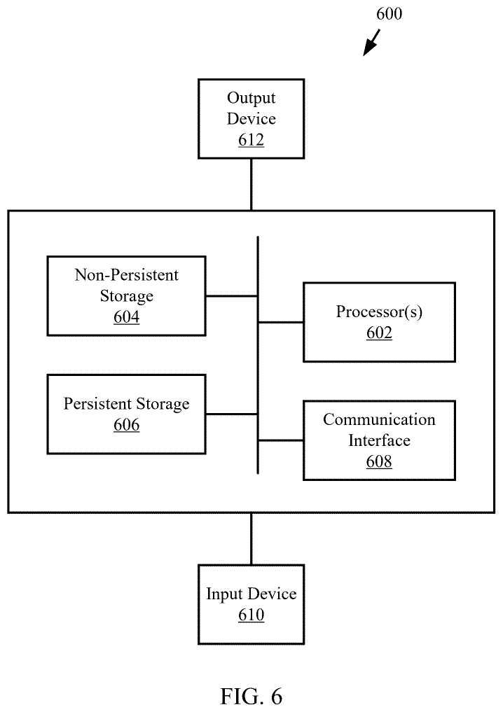

In one or more embodiments, the edge device (100) may be a physical device such as a personal computing system (e.g., a laptop, a cell phone, a tablet computer, a server, etc.) configured for hosting one or more workloads, or for providing a computing environment whereon workloads may be implemented. For example, the edge device (100) may be a computing system (e.g., 600, FIG. 6) as discussed below in more detail in FIG. 5. In one or more embodiments, the edge device (100) may include a user interface (e.g., a graphical user interface) (not shown) that allows a user to interact with applications running on the edge device (100) and the UI automation module (106). In one or more embodiments, the user uses the GUI to submit natural language inputs to the UI automation module (106).

In one or more embodiments, the edge device (100) may include any number of applications (and/or content accessible through the applications) that provide computer-implemented services to a user. In one or more embodiments, the applications may include but should not be limited to, word processing applications, spreadsheet applications, email applications/clients, database applications, presentation applications, calendar applications, etc. Applications may be designed and configured to perform one or more functions instantiated by a user of the edge device (100). In order to provide application services, each application may host similar or different components. The components may be, for example (but not limited to), instances of databases, instances of email servers, etc. Applications may be executed on one or more edge device(s) (100) as instances of the application.

Applications may vary in different embodiments, but in certain embodiments, applications may be custom-developed or commercial (e.g., off-the-shelf) applications that a user desires to execute on the edge device (100). In one or more embodiments, applications may be logical entities executed using computing resources of the edge device (100). For example, applications may be implemented as computer instructions stored on persistent storage of the edge device (100) that when executed by the processor(s) of the edge device (100), cause the edge device (100) to provide the functionality of the applications described throughout the application.

In one or more embodiments, while performing, for example, one or more operations requested by a user, applications installed on the edge device (100) may include functionality to request and use physical and logical resources of the edge device (100). Applications may also include functionality to use data stored in storage/memory resources of the edge device (100). The applications may perform other types of functionalities not listed above without departing from the scope of the embodiments disclosed herein. While providing application services to a user, applications may store data that may be relevant to the user in storage/memory resources of the edge device (100).

In one or more embodiments, to provide services to the users, the edge device (100) may utilize, rely on, or otherwise cooperate with an infrastructure node (IN) (not shown). For example, the edge device (100) may issue requests to the IN to receive responses and interact with various components of the IN. The edge device (100) may also request data from and/or send data to the IN (for example, the edge device (100) may transmit information to the IN that allows the IN to perform computations, the results of which are used by the edge device (100) to provide services to the users). As yet another example, the edge device (100) may utilize computer-implemented services provided by the IN. When the edge device (100) interacts with the IN, data that is relevant to the edge device (100) may be stored (temporarily or permanently) in the IN.

In one or more embodiments, the edge device (100) may be capable of, for example: (i) collecting users'inputs, (ii) correlating collected users'inputs to the computer-implemented services to be provided to the users, (iii) communicating with INs that perform computations necessary to provide the computer-implemented services, (iv) using the computations performed by the infrastructure nodes to provide the computer-implemented services in a manner that appears (to the users) to be performed locally to the users, and/or (v) communicating with any virtual desktop (VD) in a virtual desktop infrastructure (VDI) environment (or a virtualized architecture) provided by the IN (using any known protocol in the art), for example, to exchange remote desktop traffic or any other regular protocol traffic (so that, once authenticated, users may remotely access independent VDs).

As described above, the edge devices (100) may provide computer-implemented services to users (and/or other computing devices). The edge devices (100) may provide any number and any type of computer-implemented services. To provide computer-implemented services, an edge device (100) may include a collection of physical components (e.g., processing resources, storage/memory resources, networking resources, etc.) configured to perform operations of the edge device (100) and/or otherwise execute a collection of logical components (e.g., virtualization resources) of the edge device (100).

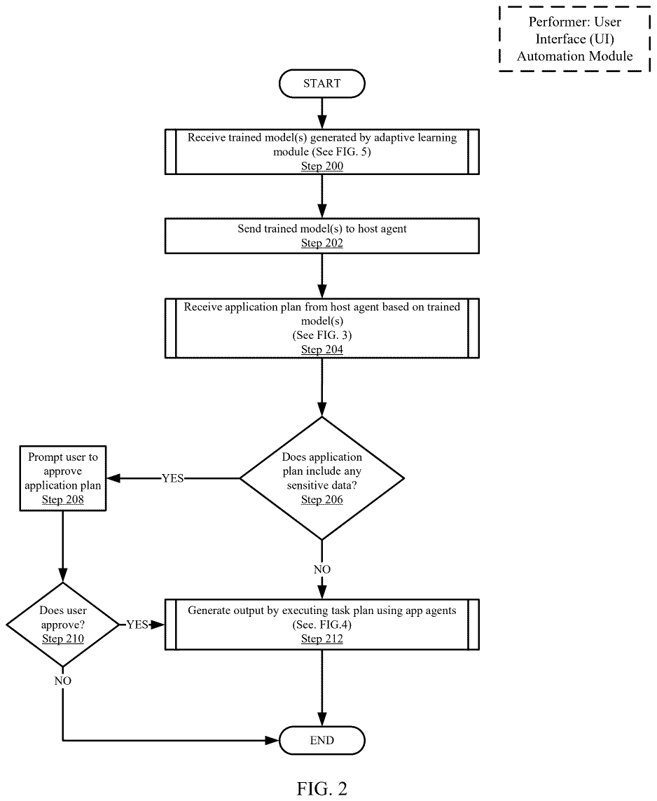

Further, the edge device (100) may include functionality to perform at least a portion of the methods shown in FIGS. 2-5. One of ordinary skill in the art will appreciate that the edge device (100) may perform other functionalities without departing from the scope of the embodiment disclosed herein.

In one or more embodiments, the remote device (104) may include any network-enabled device that is capable of establishing a connection to the edge device (100) and UI automation module (106) via the network (102). Non-limiting examples of such devices may include servers, computing devices (e.g., 600 in FIG. 6), IoT devices, IT environments, or any other device that communicates with the edge device(s) (100) to exchange data, perform processing tasks, or interact with other network components. Additionally, in one or more embodiments, the remote device (104) may include any number and any configuration of IT sub-systems, including, but not limited to, an intelligent support bundle service. Further, in one or more embodiments, the remote device (104) may represent any IT environment where operations therein may be performed independently or asynchronous to any operations transpiring throughout the edge device (100). Further, the remote device (104) may include functionality to perform at least a portion of the methods shown in FIGS. 2-5. One of ordinary skill in the art will appreciate that the remote device (104) may perform other functionalities without departing from the scope of the embodiment disclosed herein.

In one or more embodiments, the UI automation module (106) includes the functionality to automate UI task (e.g., clicking buttons, inputting text, etc.) using the host agent (108), app agent group (110), the adaptive learning module (112), the control interaction module (114), and the security module (116). In one or more embodiments, the UI automation module (106) utilizes a dual-agent framework made up of the host agent (108) and the app agent group (110) which work together to execute tasks across multiple applications (e.g., word processing applications, email applications, calendar applications, etc.). In one or more embodiments, the UI automation module (106) may utilize conformal learning techniques when automating the UI tasks. Further, the UI automation module (106) may include functionality to perform at least a portion of the methods shown in FIGS. 2-5. One of ordinary skill in the art will appreciate that the UI automation module (106) may perform other functionalities without departing from the scope of the embodiment disclosed herein.

In one or more embodiments, the host agent (108) includes the functionality to interpret natural language inputs (e.g., set up a meeting on Wednesday, Jan. 1, 2025, with John Doe) from a user and break them down into actionable tasks (i.e., individual tasks needed to fulfill the natural language input). In one or more embodiments, the host agent (108) includes the functionality to use the actionable tasks to formulate an application plan for app agents of the app agent group (110) to execute. In one or more embodiments, the application plan is a high-level road map derived from the natural language input outlining the sequence of action required for the app agents to execute in order to fulfill the input. In one or more embodiments, the application plan defines the app agents within the app agent group (110) designated to execute the actionable tasks, along with specific actions assigned to each of the app agents. In one or more embodiments, the application plan requires the app agents to perform multiple actions across different UI elements. Further, the host agent (108) may include functionality to perform at least a portion of the methods shown in FIGS. 2-5. One of ordinary skill in the art will appreciate that the host agent (108) may perform other functionalities without departing from the scope of the embodiment disclosed herein.

In one or more embodiments, the app agent group (110) includes the functionality to execute actions specified in the application plan. In one or more embodiments, the app agent group (110) includes app agents A-N, with each app agent including the functionality to execute the actions (e.g., interacting with UI elements, performing specific actions, navigating through application UIs, etc.) specified by the application plan. In one or more embodiments, the app agents of the app agent group (110) use the control interaction module (114) to interact with UI elements within applications. In one or more embodiments, interacting with UI elements refers to simulating user actions within a UI such as clicking buttons, typing, scrolling, taking screenshots, etc., to manipulate and/or retrieve data from the applications. Further, the app agent group (110) may include functionality to perform at least a portion of the methods shown in FIGS. 2-5. One of ordinary skill in the art will appreciate that the app agent group (110) may perform other functionalities without departing from the scope of the embodiment disclosed herein.

In one or more embodiments, the adaptive learning module (112) includes the functionality to generate trained models. In one or more embodiments, the trained models are used by the host agent (108) to generate the application plans, and by the app agents to execute the application plans. In one or more embodiments, the trained models use conformal prediction techniques and supervised learning algorithms. In one or more embodiments, the adaptive learning module (112) includes a repository of learned knowledge, including task execution strategies, error handling techniques, and user preferences. In one or more embodiments, the adaptive learning module (112) continuously updates the repository with new insights and best practices. Further, the adaptive learning module (112) may include functionality to perform at least a portion of the methods shown in FIGS. 2-5. One of ordinary skill in the art will appreciate that the adaptive learning module (112) may perform other functionalities without departing from the scope of the embodiment disclosed herein.

In one or more embodiments, the control interaction module (114) includes the functionality to interact with various UI elements of applications running on the edge device (100). In one or more embodiments, the control interaction module (114) module uses visual recognition techniques to accurately identify and annotate UI elements, ensuring precise interactions. In one or more embodiments, the control interaction module (114) may use any visual recognition techniques known in the art or discovered in the future. In one or more embodiments, the control interaction module (114) supports a wide range of UI actions, including but not limited to clicking, text input, scrolling, screenshots, text summarization, dragging, dropping, etc. In one or more embodiments, the control interaction module (114) may use large language models (LLMs) when interpreting and interacting with the UI elements. Further, the control interaction module (114) may include functionality to perform at least a portion of the methods shown in FIGS. 2-5. One of ordinary skill in the art will appreciate that the control interaction module (114) may perform other functionalities without departing from the scope of the embodiment disclosed herein.

In one or more embodiments, the security module (116) includes the functionality to classify actions in the application plan based on their impact and sensitivity. For example, actions that could lead to significant changes or irreversible consequences, such as sending emails, deleting files, or accessing sensitive data, are flagged as sensitive. In one or more embodiments, the security module (116) assesses each action in the application plan for potential risks, considering factors including but not limited to likelihood of errors, severity of potential consequences, context in which the action is being performed, etc. In one or more embodiments, the security module (116) places a hold on actions that have been flagged pending user confirmation. Further, the security module (116) may include functionality to perform at least a portion of the methods shown in FIGS. 2-5. One of ordinary skill in the art will appreciate that the security module (116) may perform other functionalities without departing from the scope of the embodiment disclosed herein.

In one or more embodiments, the edge device (100), the remote device (104), the UI automation module (106), the host agent (108), the app agent group (110), the adaptive learning module (112), the control interaction module (114), and the security module (116) are each implemented as a computing device (see e.g., FIG. 6). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid-state drives, etc.). The computing device may include instructions, stored on the persistent storage, that when executed by the processor(s) of the computing device cause the computing device to perform the functionality of the edge device (100), the remote device (104), the UI automation module (106), the host agent (108), the app agent group (110), the adaptive learning module (112), the control interaction module (114), and the security module (116) described throughout this application.

In one or more embodiments, the edge device (100), the remote device (104), the UI automation module (106), the host agent (108), the app agent group (110), the adaptive learning module (112), the control interaction module (114), and the security module (116) are each implemented as a logical device. The logical device may utilize the computing resources of any number of computing devices and thereby provide the functionality of the edge device (100), the remote device (104), the UI automation module (106), the host agent (108), the app agent group (110), the adaptive learning module (112), the control interaction module (114), and the security module (116).

Turning to FIG. 2, FIG. 2 shows a flowchart of a method for automating an adaptive multi-agent user interface (UI) in accordance with one or more embodiments disclosed herein. The method may be performed by, for example, a UI automation module (e.g., 106 in FIG. 1). Other components in the system may perform this method without departing from the scope of the disclosure.

While the various steps in the flowchart shown in FIG. 2 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 200, the UI automation module (e.g., 106 in FIG. 1) receives trained models generated by an adaptive learning module (e.g., 112 in FIG. 1). In one or more embodiments, the trained models enable the system can interpret user commands accurately, predict outcomes reliably, and interact with user interface (UI) elements (i.e., interactive components of a UI such as buttons, sliders, text fields, and menus that enable users to interact with a system or application) effectively as described below in FIG. 5.

In step 202, the UI automation module (e.g., 106 in FIG. 1) sends the trained models to a host agent (e.g., 108 in FIG. 1). In one or more embodiments, the UI automation module (e.g., 106 in FIG. 1) may send the trained models by any means known in the art or discovered in the future.

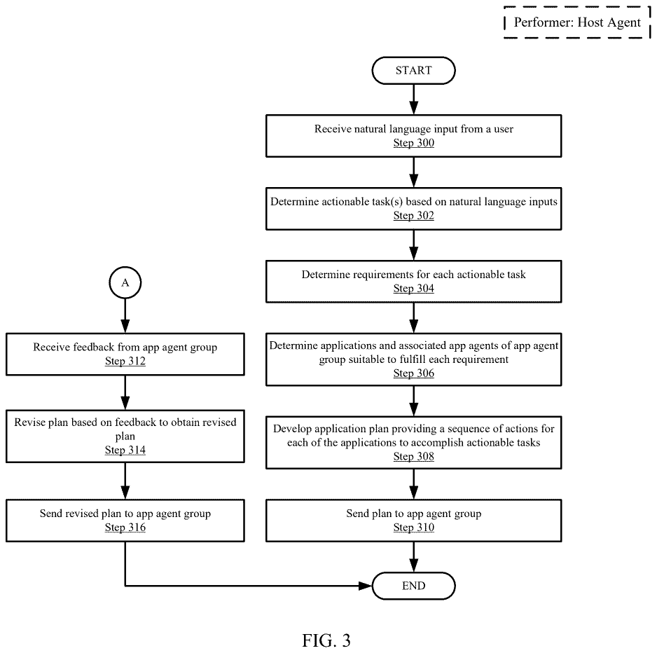

In step 204, the UI automation module (e.g., 106 in FIG. 1) receives an application plan from the host agent (e.g., 108 in FIG. 1). In one or more embodiments, the application plan is a high-level road map derived from a natural language input (e.g., “generate a spreadsheet of 2024 performance data”) outlining the sequence of actions required for app agents of an app agent group (e.g., 110 in FIG. 1) to execute in order to fulfill the user input, as described in FIG. 3. It should be appreciated, that the application plan ensures that actions are executed in a logical and efficient order. In one or more embodiment, the host agent (e.g., 108 in FIG. 1) uses trained models to generate the application plan as described in in FIG. 3.

In step 206, the security module (e.g., 116 in FIG. 1) determines whether the application plan includes any sensitive actions. In one or more embodiments, sensitive actions including but are not limited to, actions that could lead to significant changes or irreversible consequences, such as sending emails, deleting files, accessing sensitive data, etc. In one or more embodiments, each action in the application plan is assessed by the security module (e.g., 116 in FIG. 1) for its potential risks, considering factors such as the likelihood of errors, the severity of potential consequences, and the context in which the actions are being performed (e.g., if data is being sent internally within an organization versus externally, different security measures may be taken). In one or more embodiments, the security module (e.g., 116 in FIG. 1) implements context aware monitoring. In one or more embodiments, context aware monitoring refers to real time tracking and analysis of user interactions and system behavior and insights based on the specific context of usage. A non-limiting example of context aware monitoring may be recognizing a number as a bank number or credit card number based on text before or after the number. In one or more embodiments. the security module (e.g., 116 in FIG. 1) is constantly monitoring the actions as they are being executed. In one or more embodiments, the determination is based upon a predetermined threshold such as by assigning each action a sensitivity score and only assigning actions as sensitive if the sensitivity score is above the predetermined threshold. In one or more embodiments, the security module (e.g., 116 in FIG. 1) includes the functionality to learn from past interactions and adjust the predetermined threshold over time. In one or more embodiments, the security module (e.g., 116 in FIG. 1) may make the determination by any means known in the art or discovered in the future. In one or more embodiments, the security module (e.g., 116 in FIG. 1) creates a list of all the actions of the application plan that it flagged as sensitive. Accordingly, if the result is YES, then the method proceeds to step 208. If the result is NO, then the method proceeds to step 212.

In step 208, the security module (e.g., 116 in FIG. 1) prompts a user to approve the application plan. In one or more embodiments, the security module (e.g., 116 in FIG. 1) informs the user of the action(s) from the application plan that the security module (e.g., 116 in FIG. 1) flagged as sensitive. In one or more embodiments, informing the user includes displaying a detailed description of the sensitive actions, and their potential impact, and requesting explicit user consent to proceed. In one or more embodiments, the security module (e.g., 116 in FIG. 1) prompts the user via a graphical user interface (GUI) on an edge device (e.g., 100 in FIG. 1) to accept the application plan. In one or more embodiments, the security module (e.g., 116 in FIG. 1) may require the user to confirm the application plan more than once or to provide additional validation, such as entering a password or answering a security question if the actions are extra sensitive (e.g., including privileged information, the sensitivity score is above a second, higher predetermined threshold).

In step 210, the security module (e.g., 116 in FIG. 1) determines whether the user has authorized the application plan. In one or more embodiments, the security module (e.g., 116 in FIG. 1) may make this determination by any means known in the art or discovered in the future. In one or more embodiments, the user may decide to only accept a portion of the sensitive actions within the application plan resulting in a modified application plan. Accordingly, if the result is YES, then the method proceeds to step 212. If the result is NO, the method ends.

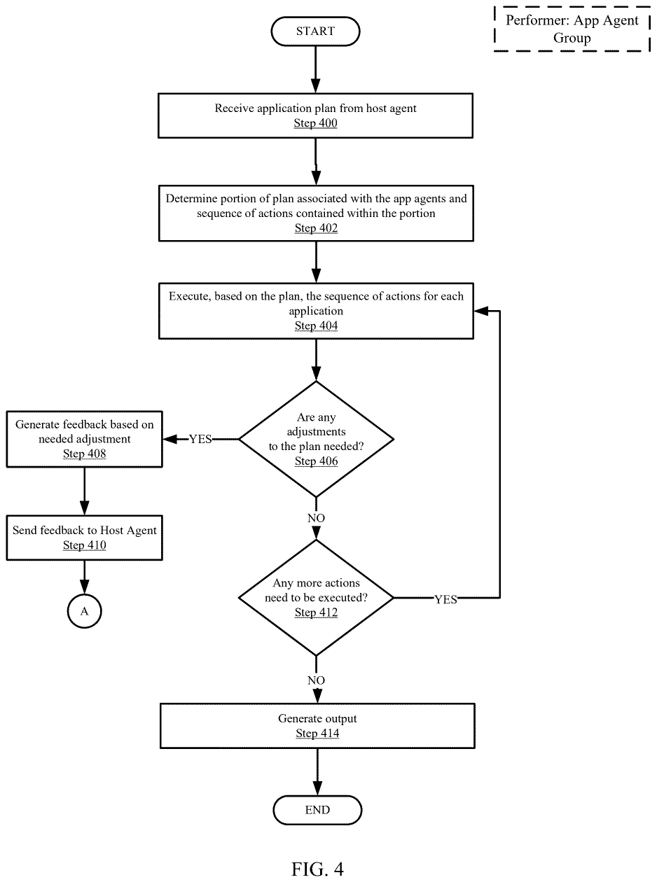

In one or more embodiments, the method may arrive at step 212 from step 206 or 210. In step 212, the app agent group (e.g., 110 in FIG. 1) generates an output using an executed application plan/modified application plan. In one or more embodiments, after the application plan is approved, the app agents of the app agent group (e.g., 110 in FIG. 1) execute it, as described in FIG. 4. In one or more embodiments, the output includes producing an execution summary, a detailed report, an error report, and collecting user feedback as a result of executing the application plan/modified application plan, as described in FIG. 4.

In one or more embodiments, the method may end following step 212.

Turning to FIG. 3, FIG. 3 shows a flowchart of a method for generating an application plan in accordance with one or more embodiments disclosed herein. The method may be performed by, for example, a host agent (e.g., 108 in FIG. 1). Other components in the system may perform this method without departing from the scope of the disclosure.

While the various steps in the flowchart shown in FIG. 3 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 300, the host agent (e.g., 108 in FIG. 1) receives a natural language input from a user. In one or more embodiments, the user may send the natural language input to the host agent (e.g., 108 in FIG. 1) via a graphical user interface (GUI) on an edge device (e.g., 100 in FIG. 1). In one or more embodiments, the natural language input may be in the form of voice or text. A non-limiting example of natural language input may be “generate a spreadsheet with performance data for each month of 2024.” In one or more embodiments, the host agent (e.g., 108 in FIG. 1) determines an intent of the natural language input. In one or more embodiments, the host agent (e.g., 108 in FIG. 1) may determine the intent of the natural language input using natural language processing (NLP) techniques known in the art or discovered in the future. In one or more embodiments, the host agent (e.g., 108 in FIG. 1) uses NLP techniques to identify entities mentioned in the input, such as specific files, contacts, or data points. In one or more embodiments, the host agent (e.g., 108 in FIG. 1) captures all mouse clicks, movements, scrolls, and keyboard inputs, including exact coordinates of mouse clicks and the timing of each input when determining the intent. In one or more embodiments, the host agent (e.g., 108 in FIG. 1) may also monitor the context of the system (e.g., what applications are open and what actions the user performed before the input) when determining the intent. In one or more embodiments, the host agent (e.g., 108 in FIG. 1) may use historical data of past user interactions when determining intent.

In step 302, the host agent (e.g., 108 in FIG. 1) determines actionable tasks based on the intent of the natural language input. In one or more embodiments, the actable tasks refer to individual tasks needed to fulfill the intent of natural language input. Continuing with the non-limiting example on step 300, the actionable tasks of the natural language input “generate a spreadsheet with performance data for each month of 2024” may include: retrieving performance data for 2024 and inputting the data into a spreadsheet. It should be appreciated, that actionable tasks may vary from those presented above and that the example provided is merely illustrative, intended to aid the understanding of those skilled in the art, without limiting the scope. In one or more embodiments, the host agent (e.g., 108 in FIG. 1) may determine the actionable tasks by any means known in the art or discovered in the future.

In step 304, the host agent (e.g., 108 in FIG. 1) determines the requirements to carry out each actionable task. In one or more embodiments, requirements may include but are not limited to what applications (e.g., word processing applications, spreadsheet applications, database applications, email applications, calendar applications, etc.) are needed to fulfill the input, how many app agents of an app agent group (e.g., 110 in FIG. 1), etc. In one or more embodiments, the host agent (e.g., 108 in FIG. 1) may determine the requirements by any means known in the art or discovered in the future.

In step 306 the host agent (e.g., 108 in FIG. 1) determines the app agents of the app agent group (e.g., 110 in FIG. 1) and the applications that are suitable for fulfilling the requirements of the actionable tasks. In one or more embodiments, the determination includes identifying app agents and applications that are currently active and best suited to perform the actionable tasks. In one or more embodiments, there may be more than one type of app agent including but not limited to automation app agents (i.e., app agents that perform actions within an application plan), monitoring app agents (i.e., app agents that monitor the state of the system during execution of the application plan), etc. Continuing with the non-limiting example in step 302, a database application and a spreadsheet application may be needed to fulfill the tasks of “retrieving performance data for 2024 and inputting the data into a spreadsheet.” In one or more embodiments, the host agent (e.g., 108 in FIG. 1) may determine the suitable app agents and applications by any means known in the art or discovered in the future.

In step 308, the host agent (e.g., 108 in FIG. 1) develops the application plan for the app agent group (e.g., 110 in FIG. 1) to execute. In one or more embodiments, the application plan is a high-level road map derived from the natural language input outlining a sequence of actions for the app agents to execute in order to fulfill the user input. In one or more embodiments, the application plan specifies the app agents of the app agent group (e.g., 110 in FIG. 1) needed to fulfill the application plan. In one or more embodiments, the application plan specifies the actions that the app agents need to perform. In one or more embodiments, the application plan specifies the applications and UI elements that the app agents must interact with to carry out the tasks. In one or more embodiments, after specifying the applications that are needed, the host agent (e.g., 108 in FIG. 1) determines whether the specified applications are ready for interaction (i.e., checking if the applications are running and if they are in a correct state for interaction (e.g., verifying that a document is open in a word processor or that an email client is ready to compose a new message) for the intended actions). In one or more embodiments, the app agents initiate the launch process (i.e., executing the necessary commands or scripts to start the applications) of applications that are not running. Further after initializing, the app agents cause the launched applications to reach the required initial state for interaction which may include but is not limited to opening specific documents, navigating to the correct interface, loading necessary data, etc. In one or more embodiments, the host agent (e.g., 108 in FIG. 1) determines the most efficient order that the actions should be performed. In one or more embodiments, the application plan specifies an order that the actions are to be performed. In one or more embodiments, a control interaction module (e.g., 114 in FIG. 1) generates a detailed map of each application's UI elements which the host agent (e.g., 108 in FIG. 1) uses when developing the application plan. In one or more embodiments, the host agent (e.g., 108 in FIG. 1) uses a trained model to generate the application plan, as described in FIG. 5. In one or more embodiments, the host agent (e.g., 108 in FIG. 1) uses confidence scores from the trained models to guide decision making when generating the application plan, as described in FIG. 5. In one or more embodiments, the trained models produce confidence scores for each possible action of the application plan which the host agent (e.g., 108 in FIG. 1) considers when developing the actions plan (e.g., the trained model has 99% confidence that the app agents should retrieve data from a database before placing any data in a spreadsheet application). In one or more embodiments, the host agent (e.g., 108 in FIG. 1) prioritizes actions with higher confidence levels (e.g., the trained model is 90% confident that the spreadsheet application should be used to generate a spreadsheet and 50% confident that a word processing application should be used to generate a spreadsheet). In one or more embodiments, the confidence scores are based upon feedback (e.g., system and user feedback), and outcomes of past application plans. Continuing with the non-limiting example in step 304, the sequence of actions to fulfill the actionable tasks of “retrieving performance data for 2024 and inputting the data into a spreadsheet” may include: 1) obtaining 2024 performance data from database application, 2) sorting performance data by month, 3) inserting performance data in spreadsheet application as a table, and 4) using spreadsheet UI to highlight the first row and column of the table. It should be appreciated, that the sequence of actions may vary from those presented above and that the example provided is merely illustrative, intended to aid the understanding of those skilled in the art, without limiting the scope. In one or more embodiments, the host agent (e.g., 108 in FIG. 1) may develop the application plan by any means known in the art or discovered in the future.

In step 310, the host agent (e.g., 108 in FIG. 1) sends the application plan to the app agent group (e.g., 110 in FIG. 1). In one or more embodiments, the host agent (e.g., 108 in FIG. 1) may send the application plan to the app agent group (e.g., 110 in FIG. 1) by any means known in the art or discovered in the future.

In one or more embodiments, the method may end following step 310.

In step 312, the host agent (e.g., 108 in FIG. 1) receives feedback about the application plan from the app agent group (e.g., 110 in FIG. 1). In one or more embodiments, the feedback may identify certain actions within the application plan that consistently fail or succeed under specific conditions.

In step 314, the host agent (e.g., 108 in FIG. 1) revises the application plan based on the feedback. In one or more embodiments, revising the plan may include but should not be limited to changing the order the actions are performed, reassigning the app agents of the app agent group (e.g., 110 in FIG. 1) to new actions, using different applications, etc.

In step 316, the host agent (e.g., 108 in FIG. 1) sends the revised application plan to the app agent group (e.g., 110 in FIG. 1). In one or more embodiments, the host agent (e.g., 108 in FIG. 1) may send the revised application plan to the app agent group (e.g., 110 in FIG. 1) by any means known in the art or discovered in the future.

In one or more embodiments, the method may end following step 316.

Turning to FIG. 4, FIG. 4 shows a flowchart of a method for executing an application plan in accordance with one or more embodiments disclosed herein. The method may be performed by, for example, an app agent group (e.g., 110 in FIG. 1). Other components in the system may perform this method without departing from the scope of the disclosure.

While the various steps in the flowchart shown in FIG. 4 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 400, the app agent group (e.g., 110 in FIG. 1) receives the application plan (i.e., a high-level road map derived from a natural language input outlining the sequence of actions required for the app agents to execute to fulfill the input) from a host agent (e.g., 108 in FIG. 1). In one or more embodiments, the application plan specifies the individual app agents that are needed to perform the sequence of actions and the order (i.e., sequence) in which the actions are to be performed. In one or more embodiments, the application plan may be a revised application plan generated by feedback from app agents that executed a previous application plan.

In step 402, the app agent group (e.g., 110 in FIG. 1) determines the sequence of actions that are contained within the application plan, and app agents of the app agent group (e.g., 110 in FIG. 1) suitable to carry out the sequence of actions. In one or more embodiments, there may be more than one type of app agent (e.g., automation app agents, monitoring app agents, etc.) within the app agent group (e.g., 110 in FIG. 1). In one or more embodiments, some app agents may be more suitable than others to carry out the actionable tasks. For example, a monitoring app agent may be best at monitoring the state of the UI and the automation app agents may be useful in populating a spreadsheet.

In step 404, the app agents of the app agent group (e.g., 110 in FIG. 1) execute the sequence of actions specified by the application plan. In one or more embodiments, the sequence of actions includes interacting with UI elements, performing specific actions, and navigating through application interfaces. In one or more embodiments, the app agents take screenshots before and after each action is executed. In one or more embodiments, the screenshots serve as reference points for verifying the success of actions and for rollback purposes in case of errors. In one or more embodiments, the screenshots are stored in a structured format (e.g., JSON objects, database entries, serialized files, etc.) that can be easily accessed and used during task execution. In one or more embodiments, the before and after screenshots are used to understand the visual changes as a result of the actions and to verify success of the actions. In one or more embodiments, the app agents use a control interaction module (e.g., 114 in FIG. 1) to interact with the UI elements of the applications. In one or more embodiments, the control interaction module (e.g., 114 in FIG. 1) module uses visual recognition techniques to accurately identify and annotate UI elements, providing precise interactions. In one or more embodiments, the control interaction module (e.g., 114 in FIG. 1) may use any visual recognition techniques known in the art or discovered in the future. In one or more embodiments, the control interaction module (e.g., 114 in FIG. 1) supports a wide range of UI actions, including but not limited to clicking (e.g., left-clicking, right-clicking, double-clicking, dragging, etc.), text input, text editing, text extraction, scrolling (e.g., horizontal and vertically), screenshots, text summarization, dragging, dropping, etc. In one or more embodiments, the control interaction module (e.g., 114 in FIG. 1) may use large language models (LLMs) when interpreting and interacting with the UI elements. In one or more embodiments, the control interaction module (e.g., 114 in FIG. 1) includes the functionality to interact with multiple UI elements across multiple applications at once. In one or more embodiments, the control interaction module (e.g., 114 in FIG. 1) generates a detailed map of each application's UI elements on the system for the app agents to use when executing the actions of the application plan. In one or more embodiments, the control interaction module (e.g., 114 in FIG. 1) filters out unimportant UI elements not relevant to the actions of the application to allow the app agents to operate more efficiently. In one or more embodiments, the control interaction module (e.g., 114 in FIG. 1) adjusts how it interacts with the UI elements based on changes to the UI and new conditions introduced into the system (e.g., the location of a UI element within an application may change after an update has been applied to the application). In one or more embodiments, before the app agents execute the actions in each application, they use the control interaction module (e.g., 114 in FIG. 1) to capture the state of the application's UI (i.e., identifying visible UI elements, their properties (e.g., enabled, disabled, visible, hidden), and their positions). In one or more embodiments, before the app agents execute the application plan, the app agents verify that the context of the applications matches the requirements for the planned actions (e.g., verifying that a spreadsheet is in edit mode or that an email client is displaying the compose window). In one or more embodiments, the app agents record the properties of the UI elements as they execute the application plan (e.g., their types, states, and positions). It should be appreciated, that this will make future interactions more efficient and precise. In one or more embodiments, the control interaction module (e.g., 114 in FIG. 1) verifies that the UI elements are ready to be used for interaction. In one or more embodiments, the control interaction module (e.g., 114 in FIG. 1) adjusts the application windows and screen layout to ensure that all necessary UI elements are visible and accessible (e.g., maximizing windows, resizing panes, scrolling to the correct positions in the applications, etc.). In one or more embodiments, if the app agents encounter any errors the app agents may take recovery actions including but not limited to, reloading applications, resetting UI elements, etc. In the events that the errors cannot be corrected, the app agents implement fallback procedures including but not limited to notifying the user, logging the error, and moving on to the next action, if possible.

In one or more embodiments, the app agents of the app agent group (e.g., 110 in FIG. 1) may use trained models when executing the actions of the application plan. In one or more embodiments, the trained models produce confidence intervals for the possible action that the app agents can take in accordance with the application plan. In one or more embodiments, the app agents may determine that while the application plan instructs the app agents to perform a certain action, the app agents should perform an alternative task based on the confidence levels of the trained models. In a non-limiting example, in step one of an application plan for generating an email, the application plan instructs app agents to input text into an email application first and retrieve data from a database application second, but the trained model has 80% confidence that the app agents should retrieve data from a database first and 40% confidence that the app agents should input text into email application first. In one or more embodiments, the app agents prioritize actions with higher confidence levels. Accordingly, the app agents would retrieve data from the database application first and input text into the email application second. In one or more embodiments, the app agents may log deviations from the application plan.

In step 406, the app agent group (e.g., 110 in FIG. 1) determines whether any adjustments need to be made to the application plan. In one or more embodiments, the app agent group (e.g., 110 in FIG. 1) may make this determination by any means known in the art or discovered in the future. In one or more embodiments, the app agent group (e.g., 110 in FIG. 1) is constantly monitoring the state of the UI as the application plan is executed. In one or more embodiments, the app agent group (e.g., 110 in FIG. 1) may monitor for changes to the UI, errors when carrying out the application plan, security risks, etc. In one or more embodiments, errors may include but are not limited to, missing UI elements, applications not in the expected state, unexpected dialog boxes, application failure, etc. Accordingly, in one or more embodiments, if the result is YES then the method proceeds to step 408. If the result is NO, the method proceeds to step 412.

As a result of determining that adjustments need to be made, the method arrives at step 408. In step 408, the app agent group (e.g., 110 in FIG. 1) generates feedback based on the adjustments that are needed. In a non-limiting example, the feedback may identify certain actions within the application plan that consistently fail or succeed under specific conditions. In one or more embodiments, the feedback may include any deviations that the app agents took from the application plan based on the confidence levels as discussed in step 404.

In step 410, the app agent group (e.g., 110 in FIG. 1) sends the feedback to the host agent (e.g., 108 in FIG. 1). In one or more embodiments, the feedback may be sent to the host agent (e.g., 108 in FIG. 1) by any means known in the art or discovered in the future. The method then proceeds to step 312 in FIG. 3.

As a result of the determination in step 406 that no adjustments need to be made, the method arrives at step 412. In step 412, the app agent group (e.g., 110 in FIG. 1) determines if any more actions in the application need to be executed. In one or more embodiments, the app agent group (e.g., 110 in FIG. 1) may make this determination by any means known in the art or discovered in the future. In one or more embodiments, the app agent group (e.g., 110 in FIG. 1) may notify the user when all the actions have been completed via a graphical user interface (GUI) (e.g., pop-up notifications, email alerts, in-app messages, etc.). In one or more embodiments, the app agent group (e.g., 110 in FIG. 1) may verify the consistency of the system state post-execution (i.e., ensuring that all UI elements are in the expected state and that no unintended changes have occurred). Accordingly, if the result is YES then the method proceeds to step 404. If the result is NO, then the method proceeds to step 414. In one or more embodiments, steps 404, 406, and 412 may repeat until the result is NO.

As a result of the determination that no more actions need to be executed in step 412, the method proceeds to step 414. In step 414, the app agent group (e.g., 110 in FIG. 1) generates an output for the user. In one or more embodiments, the output includes producing an execution summary, a detailed report, and an error report. In one or more embodiments, the execution summary includes a high-level overview of the tasks performed, the actions taken, and the overall outcome. In one or more embodiments, the detailed report includes a detailed report that includes specific actions performed, outcomes of each action, errors encountered, and corrective measures taken. In one or more embodiments, the error report includes a lot of all the errors encountered during the execution process. In one or more embodiments, the error log includes details of the errors, the actions that caused them, the corrective actions taken to resolve the errors, and the final resolution (i.e., the result of the corrective actions and if they were successful). In one or more embodiments, the error report provides detailed information about the errors and guidance on how to address or prevent them in the future. In one or more embodiments, the output is presented with visual aids including but not limited to graphs, charts, etc. In one or more embodiments, the output also includes feedback collection (i.e., soliciting feedback from the user about the execution of the application plan including but not limited to questions about accuracy of the actions executed, usability of the system after all of the actions were executed, and any suggestions for improvement). In one or more embodiments, the output includes providing the user with options to customize the system's behavior including but not limited to setting preferences for interaction styles, task execution sequences, and error handling approaches. In a non-limiting example, a user may prefer certain font style or font size when writing emails. In one or more embodiments, the output may be presented to the user via a GUI on the edge device (e.g., 100 in FIG. 1).

In one or more embodiments, along with the output, the app agents perform restorative operations such as reverting any temporary changes made to the system during the execution of the application plan (e.g., closing any opened windows in the applications that were used in the application plan, restoring the application states, and resetting UI elements of the applications to their initial conditions, etc.). In one or more embodiments, the app agents may also perform cleanup operations, including but limited to, deleting temporary files, clearing caches, and releasing resources used during the execution of the application plan, etc. In one or more embodiments, following the restorative operations and the cleanup operations the app agents may verify that the system has been restored to its initial state and that all applications are in their expected configurations. Further, in one or more embodiments, the app agents may verify that the system is stable post executions (e.g., checking for any lingering issues that might affect future operations).

In one or more embodiments, the method may end following step 414.

Turning to FIG. 5, FIG. 5 shows a flowchart of a method for generating trained models in accordance with one or more embodiments disclosed herein. The method may be performed by, for example, an adaptive learning module (e.g., 112 in FIG. 1). Other components in the system may perform this method without departing from the scope of the disclosure.

While the various steps in the flowchart shown in FIG. 5 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 500, the adaptive learning module (e.g., 112 in FIG. 1) collects interaction data from user interactions with the system (e.g., requests, feedback, interactions with the UI of applications, etc.), a host agent (e.g., 108 in FIG. 1), and an app agent group (e.g., 110 in FIG. 1). In one or more embodiments, the data may include success rates and outcomes of various actions executed by app agents of the app agent group (e.g., 110 in FIG. 1) and success rates and outcomes associated with application plans (i.e., a high-level road map derived from a natural language input outlining a sequence of actions required for the app agents to execute to fulfill the user input) created by the host agent (e.g., 108 in FIG. 1). In one or more embodiments, the adaptive learning module (e.g., 112 in FIG. 1) may collect information about the UI elements on applications (e.g., word processing applications, email applications, calendar applications, etc.) running on the system. In one or more embodiments, information about the UI elements includes but not limited to types of UI elements (e.g., buttons, text boxes, etc.), positions, sizes, and states (e.g., enabled, disabled, visible, hidden). In one or more embodiments, the adaptive learning module (e.g., 112 in FIG. 1) may map out the hierarchical structure of UI elements, showing the parent-child relationships between different components in the application (e.g., in a word processing application components may include but should not be limited to, a spell checker, a font selector, text editor, etc.) using an interface control module (e.g., 114 in FIG. 1). In one or more embodiments, the adaptive learning module (e.g., 112 in FIG. 1) collects historical data (e.g., actions performed by the app agents, the sequence of actions, time taken for each action, outcomes of the actions, etc.), outcome data (e.g., success rates of different actions, conditions under which the actions were successful or unsuccessful, etc.), error logs associated with the actions (e.g., nature of the errors, steps leading up to the errors, error messages generated by the system or the application as a result of the errors, etc.). In one or more embodiments, the data may also include performance indicators of each application plan including but not limited to completion time, error rates, user satisfaction scores, etc. In one or more embodiments, the adaptive learning module (e.g., 112 in FIG. 1) may collect the interaction data by any means known in the art or discovered in the future.

In step 502, the adaptive learning module (e.g., 112 in FIG. 1) collects contextual data about the state of the UI of one or more applications. In one or more embodiments, contextual data includes information about a current state of applications running on an edge device (e.g., 100 in FIG. 1) including but not limited to which windows are open, the focus of the current window (i.e., what the applications are being used for), and how the user is using the UI elements within the application. In one or more embodiments, the contextual data also includes information about the system as a whole including but not limited to information about the user's operating environment, such as system configurations, screen resolution, active processes, available applications, etc. In one or more embodiments, the adaptive learning module (e.g., 112 in FIG. 1) may collect contextual data by any means known in the art or discovered in the future.

In step 504, the adaptive learning module (e.g., 112 in FIG. 1) collects feedback data. In one or more embodiments, the feedback data includes user feedback data, and app agent feedback data, as described in FIG. 4. In one or more embodiments, user feedback data includes explicit feedback provided by the user or implicit feedback inferred from repeated attempts or corrections to executed application plans. In one or more embodiments, the user feedback may also include user preferences (e.g., a user always highlights the top row of spreadsheets). In one or more embodiments, the app agent feedback includes information about the application plans (i.e., certain actions within the application plan that consistently fail or succeed under specific conditions). In one or more embodiments, the adaptive learning module (e.g., 112 in FIG. 1) may collect the feedback data by any means known in the art or discovered in the future.

In step 506, the adaptive learning module (e.g., 112 in FIG. 1) trains a model using the interaction data, the contextual data and the feedback data. In one or more embodiments, before the model is trained, the adaptive learning module (e.g., 112 in FIG. 1) pre-processes the data to clean and format it properly to ensure a smooth training process (e.g., removing noise, handling missing values, normalizing data, converting raw interaction logs into structured formats suitable for model training, etc.). In one or more embodiments, after pre-processing the data, the adaptive learning module (e.g., 112 in FIG. 1) extracts relevant features from the data including but not limited to UI element properties (e.g., type, position, and state), user action types (e.g., click and input text), contextual information (e.g., application state and user environment), and historical success rates. In one or more embodiments, the adaptive learning module (e.g., 112 in FIG. 1) continuously updates the trained models as new data is collected. In one or more embodiments, the adaptive learning module (e.g., 112 in FIG. 1), monitors the outcomes of the UI automation module (e.g., 106 in FIG. 1) in real time and updates the models accordingly. In one or more embodiments, the trained models use machine learning techniques to generalize (i.e., handle new tasks the same way similar tasks were handled) from experience, feedback, and context, enabling them to handle novel tasks that they have not encountered before (e.g., interacting with a new UI element in an application). In one or more embodiments, the trained models are supervised learning models trained using labeled data where the labels indicate correct actions and outcomes allowing the models to learn from examples. In one or more embodiments, the supervised learning models use decision trees, support vector machines (SVM), and/or neural networks to learn. In one or more embodiments, the trained models integrate conformal prediction techniques to generate confidence intervals for predictions (i.e., training models that not only predict actions but also provide confidence measures for each prediction, enhancing reliability and enabling informed decision-making). In a non-limiting example, if the model was predicting house prices, instead of saying “the house costs $350,000” it might find that the price is between $340,000 and $360,000 with 90% confidence.

It should be appreciated, that this approach provides predictions that are more reliable by accounting for uncertainty helping the UI automation model (e.g., 106 in FIG. 1) make informed decisions. In one or more embodiments, the model determines its confidence by analyzing how well similar predictions matched actual outcomes when training. In one or more embodiments, the trained models are validated and tested using separate data sets to assess their accuracy and performance (i.e., measuring metrics such as precision, recall, F1 score, reliability of the confidence intervals, etc.). In one or more embodiments, the models are trained with adaptive error recovery mechanisms that learn from past errors and improve corrective actions. In one or more embodiments, the adaptive learning module (e.g., 112 in FIG. 1) has a repository of learned knowledge, including task execution strategies, error handling techniques, and user preferences. In one or more embodiments, the adaptive learning module (e.g., 112 in FIG. 1) continuously updates the repository with new insights and best practices. In one or more embodiments, the adaptive learning module (e.g., 112 in FIG. 1) documents significant changes, model updates, and improvements in the system. In one or more embodiments, the model may adapt to the uses prefaces (e.g., if every time the user receives a spreadsheet from the system the user highlights the first row of spreadsheets, then the model will understand that the app agents should also highlight the first row of the spreadsheet when executing spreadsheet related applications plans so that the user does not have to in the future). In one or more embodiments, the adaptive learning module (e.g., 112 in FIG. 1) may leverage crowdsourced data and feedback to enhance the system's learning capabilities. In one or more embodiments, the models may be trained by any means known to in the art or discovered in the future.

In step 508, the adaptive learning module (e.g., 112 in FIG. 1) sends the trained model to the host agent (e.g., 108 in FIG. 1). In one or more embodiments, the adaptive learning module (e.g., 112 in FIG. 1) may send the trained model to the host agent (e.g., 108 in FIG. 1) by any means known in the art or discovered in the future. In one or more embodiments, the host agent (e.g., 108 in FIG. 1) uses the trained models to create the application plans, as described in FIG. 3. In one or more embodiments, the adaptive learning module (e.g., 112 in FIG. 1) may send the trained models to the host agent (e.g., 108 in FIG. 1) every time that the trained models are updated.

In one or more embodiments the method may end following step 508.

Embodiments of the disclosure may be implemented using computing devices. Turning to FIG. 6, FIG. 6 shows a diagram of a computing device (600) in accordance with one or more embodiments. The computing device (600) may include one or more computer processor(s) (602), non-persistent storage (604) (e.g., volatile memory, such as random access memory (RAM), cache memory), persistent storage (606) (e.g., a hard disk, an optical drive such as a compact disk (CD) drive or digital versatile disk (DVD) drive, a flash memory, etc.), a communication interface (608) (e.g., Bluetooth interface, infrared interface, network interface, optical interface, etc.), input devices (610), output devices (612), and numerous other elements (not shown) and functionalities. Each of these components is described below.

In one embodiment, the computer processor(s) (602) may be an integrated circuit for processing instructions. For example, the computer processor(s) (602) may be one or more cores or micro-cores of a processor. The computing device (600) may also include one or more input devices (610), such as a touchscreen, access keyboard, mouse, microphone, touchpad, electronic pen, or any other type of input device. The communication interface (608) may include an integrated circuit for connecting the computing device (600) to a network (not shown) (e.g., a local area network (LAN), a wide area network (WAN) such as the Internet, mobile network, or any other type of network) and/or to another device, such as another computing device.

In one embodiment, the computing device (600) may include one or more output devices (612), such as a screen (e.g., a liquid crystal display (LCD), a plasma display, touchscreen, cathode ray tube (CRT) monitor, projector, or other display device), a printer, external storage, or any other output device. One or more of the output devices (612) may be the same or different from the input devices (610). The input and output device(s) (610, 612) may be locally or remotely connected to the computer processor(s) (602), non-persistent storage (604), and persistent storage (606). Many diverse types of computing devices exist, and the aforementioned input and output device(s) (610, 612) may take other forms.

The problems discussed above should be understood as being examples of problems solved by embodiments of the disclosure and the disclosure should not be limited to solving the same/similar problems. The disclosed disclosure is broadly applicable to address a range of problems beyond those discussed herein.

In the detailed description of the embodiments of the disclosure above, numerous specific details are set forth in order to provide a more thorough understanding of one or more embodiments of the disclosure. However, it will be apparent to one of ordinary skill in the art that the one or more embodiments of the disclosure may be practiced without these specific details. In other instances, well-known features have not been described in detail to avoid unnecessarily complicating the description.

In the prior description of the figures, any component described with regard to a figure, in various embodiments of the disclosure, may be equivalent to one or more like-named components described with regard to any other figure. For brevity, descriptions of these components are not repeated with regard to each figure. Thus, each and every embodiment of the components of each figure is incorporated by reference and assumed to be optionally present within every other figure having one or more like-named components. Additionally, in accordance with various embodiments of the disclosure, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, throughout this application, elements of figures may be labeled as A to N. As used herein, the aforementioned labeling means that the element may include any number of items and does not require that the element include the same number of elements as any other item labeled as A to N unless otherwise specified. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

Software instructions in the form of computer readable program code to perform embodiments described herein may be stored, in whole or in part, temporarily or permanently, on a non-transitory computer readable medium such as a CD, DVD, storage device, a diskette, a tape, flash memory, physical memory, or any other physical computer readable storage medium. Specifically, the software instructions may correspond to computer readable program code that, when executed by a processor(s), is configured to perform one or more embodiments described herein.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims below.

What is claimed is:

1. A method for automating an adaptive multi-agent user interface (UI), the method comprising:
receiving at least one trained model from an adaptive learning module;
sending the at least one trained model to a host agent;
generating, using a user input as an input to the at least one trained model, an application plan via the host agent, wherein the application plan comprises a first instruction for a first app agent and a second instruction for a second app agent;
executing, using the application plan, the first instruction using the first app agent, wherein the executing includes performing at least one UI task;
executing, using the application plan, the second instruction using the second app agent; and
generating, based on executing the first instruction and the second instruction, an output to a user.

2. The method of claim 1, wherein the output includes at least one of: an execution summary, an error report, a completion notification, and user feedback solicitation.

3. The method of claim 1, wherein the UI task includes at least one of: executing one or more operators in a UI, entering text into the UI, and capturing screenshots of the UI.

4. The method of claim 1 further comprising:
prior to executing the first instruction and the second instruction:
making a first determination that the application plan includes sensitive information;
prompting, based on the first determination, a user to approve the application plan; and
making a second determination that the user approved the application plan.

5. The method of claim 1, further comprising:
prior to generating the output to the user:
making a third determination that adjustments for the application plan are required;
generating feedback based on the third determination; and
sending the feedback to the host agent.

6. The method of claim 5, further comprising:
receiving, by the host agent, feedback about the application plan;
revising the application plan based upon the feedback; and
sending, by the host agent, the revised application plan to the first app agent and the second app agent.

7. The method of claim 1, further comprising:
prior to generating the output to the user:
making a fourth determination that no adjustments to the application plan are required;
making, based on the fourth determination and the application plan, a fifth determination, that a third instruction needs to be executed; and
executing, based upon the fifth determination, using the first app agent, the third instruction.

8. The method of claim 1, wherein the at least one trained model is trained by:
collecting, by an adaptive learning module, interaction data from user interactions with a user interface (UI), contextual data about a state of the UI, and feedback data; and
generating the at least one trained model using the interaction data from the user interactions with the UI, the contextual data about the state of the UI, and the feedback data.

9. A non-transitory computer readable medium (CRM) comprising computer readable program code, which when executed by a computer processor, enables the computer to perform a method for automating an adaptive multi-agent user interface (UI), the method comprising:
receiving at least one trained model from an adaptive learning module;
sending the at least one trained model to a host agent;
generating, using a user input as an input to the at least one trained model, an application plan via the host agent, wherein the application plan comprises a first instruction for a first app agent and a second instruction for a second app agent;
executing, using the application plan, the first instruction using the first app agent, wherein the executing includes performing at least one UI task;
executing, using the application plan, the second instruction using the second app agent; and
generating, based on executing the first instruction and the second instruction, an output to a user.

10. The non-transitory CRM of claim 9, wherein the output includes at least one of: an execution summary, an error report, a completion notification, and user feedback solicitation.

11. The non-transitory CRM of claim 9, wherein the UI task includes at least one of: executing one or more operators in a UI, entering text into the UI, and capturing screenshots of the UI.

12. The non-transitory CRM of claim 9, further comprising:
prior to executing the first instruction and the second instruction:
making a first determination that the application plan includes sensitive information;
prompting, based on the first determination, a user to approve the application plan; and
making a second determination that the user approved the application plan.

13. The non-transitory CRM of claim 9, further comprising:
prior to generating the output to the user:
making a third determination that adjustments for the application plan are required;
generating feedback based on the third determination; and
sending the feedback to the host agent.

14. The non-transitory CRM of claim 13, further comprising:
receiving, by the host agent, feedback about the application plan;
revising the application plan based upon the feedback; and
sending, by the host agent, the revised application plan to the first app agent and the second app agent.

15. A system for automating an adaptive multi-agent user interface (UI), the system comprising:
persistent storage; and
a computing device, comprising a processor and memory, programmed to:
receive at least one trained model from an adaptive learning module;
send the at least one trained model to a host agent;
generate, using a user input as an input to the at least one trained model, an application plan via the host agent, wherein the application plan comprises a first instruction for a first app agent and a second instruction for a second app agent;
execute, using the application plan, the first instruction using the first app agent, wherein the executing includes performing at least one UI task;
execute, using the application plan, the second instruction using the second app agent; and
generate, based on executing the first instruction and the second instruction, an output to a user.

16. The system of claim 15, wherein the output includes at least one of: an execution summary, an error report, a completion notification, and user feedback solicitation.

17. The system of claim 15, wherein the UI task includes at least one of: executing one or more operators in a UI, entering text into the UI, and capturing screenshots of the UI.

18. The system of claim 15, wherein the computing device is further programmed to:
prior to executing the first instruction and the second instruction:
make a first determination that the application plan includes sensitive information;
prompt, based on the first determination, a user to approve the application plan; and
make a second determination that the user approved the application plan.

19. The system of claim 15, wherein the computing device is further programmed to:
prior to generating the output to the user:
make a third determination that adjustments for the application plan are required;
generate feedback based on the third determination; and
send the feedback to the host agent.

20. The system of claim 19, wherein the computing device is further programmed to:
receive, by the host agent, feedback about the application plan;
revise the application plan based upon the feedback; and
send, by the host agent, the revised application plan to the first app agent and the second app agent.
